(19) United States
(12) Patent Application Publication
(10) Pub. No.: US 2025/0282975 A1
(43) Pub. Date: Sep. 11, 2025

(54) AQUEOUS POLYOL DISPERSION AND PREPARATION METHOD THEREOF AND APPLICATION THEREOF

(71) Applicant: GUANGZHOU GUANZHI NEW MATERIAL TECHNOLOGY CO., LTD., Guangzhou City (CN)

(72) Inventors: Xing TAN, Guangzhou City (CN); Jie OUYANG, Guangzhou City (CN); Zikun LIN, Guangzhou City (CN); Hongbin CHEN, Guangzhou City (CN)

(21) Appl. No.: 19/058,134

(22) Filed: Feb. 20, 2025

(30) Foreign Application Priority Data
Mar. 11, 2024 (CN) 202410271787.9

(51) Int. Cl. C09D 169/00; C09D 5/02; C09D 7/20; C09D 7/45; C09D 7/65

(52) U.S. Cl. CPC C09D 169/005; C09D 5/022; C09D 5/027; C09D 7/20; C09D 7/45; C09D 7/65

(57) ABSTRACT

An aqueous polyol dispersion and preparation method thereof and application thereof is provided. The aqueous polyol dispersion of the present application includes a polycarbonate diol, a non-ionic emulsifier and water; wherein, the polycarbonate diol is at least one type of a polycarbonate diol including (a), (b) and (c), wherein: (a) is a terminal hydroxyl group; (b) is a repeating unit represented by formula; (c) is at least one of a repeating unit represented by formula, a repeating unit represented by formula and a repeating unit represented by formula; the non-ionic emulsifier is at least one emulsifier including alternating polyoxyethylene segment and polyoxypropylene segment, and a molar ratio of the polyoxyethylene segment to a sum of the polyoxyethylene segment and the polyoxypropylene segment is 35-85%.

### CROSS-REFERENCE TO RELATED APPLICATION

This application claims priority to Chinese Patent Application No. 202410271787.9 filed on Mar. 11, 2024, the entire content of which is hereby incorporated by reference.

### FIELD OF TECHNOLOGY

The following relates to the technical field of aqueous coating, and in particular to an aqueous polyol dispersion and preparation method thereof and application thereof.

### BACKGROUND

With improvement of people's living standards, there is an increasing demand for tactile feel in plastic coating, leather coating and wood coating. Coatings with flexible tactile feel and good abrasion resistance are widely loved. In embodiments, environmentally friendly and low VOC aqueous soft-feel polymers have become a focus of research.

CN107011495A discloses a soft-feel aqueous polyurethane dispersion, which is obtained by a reaction of an organic polyisocyanate compound, a polycarbonate diol with a specific structure, and a compound containing a carboxyl group and/or a sulfo group. A coating film prepared therefrom demonstrates excellent soft-feel. However, a resin prepared by this method is essentially free of hydroxyl groups, and no water-dispersed isocyanate curing agent is added during its application. Therefore, the coating film has a low cross-linking density and poor chemical resistance.

CN111094373A discloses an aqueous two-component soft-feel coating, which consists of a hydroxyl-containing polyurethane dispersion, a hydroxyl-free polyurethane dispersion and a water-dispersed isocyanate curing agent. A coating film prepared therefrom demonstrates good soft-feel and excellent chemical resistance. However, scratch and abrasion resistance of the coating film prepared by this method is still not adequate, and does not meet requirements for high demand aqueous plastic coatings.

All of the above-mentioned aqueous soft-feel resins have certain defects, and there is a need for an aqueous resin with better abrasion resistance and enhanced soft-feel.

### SUMMARY

An aspect relates to an aqueous polyol dispersion is disclosed and includes: a polycarbonate diol, a non-ionic emulsifier and water;
wherein, the polycarbonate diol is at least one type of polycarbonate diol including (a), (b), and (c), wherein:
(a) is a terminal hydroxyl group;
(b) is a repeating unit represented by formula (1);

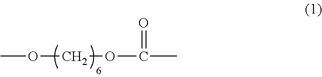

(c) is at least one of a repeating unit represented by formula (2), a repeating unit represented by formula (3) and a repeating unit represented by formula (4);

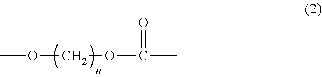

in formula (2), n is either 4 or 5;

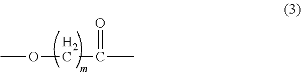

in formula (3), m is either 4 or 5;

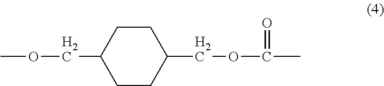

in the polycarbonate diol,

$$\frac{{n}_{l}}{{n}_{1} + {n}_{2} + {n}_{3} + {n}_{4}} = 25 - 75 \% ; \frac{{n}_{2}}{{n}_{1} + {n}_{2} + {n}_{3} + {n}_{4}} = 0 - 75 \% ; \frac{{n}_{3}}{{n}_{1} + {n}_{2} + {n}_{3} + {n}_{4}} = 0 - 30 \% ; \\ \frac{{n}_{4}}{{n}_{1} + {n}_{2} + {n}_{3} + {n}_{4}} = 0 - 30 \% ;$$

n1 represents a molar amount of the repeating unit represented by formula (1); n2 represents a molar amount of the repeating unit represented by formula (2); n3 represents a molar amount of the repeating unit represented by formula (3); n4 represents a molar amount of the repeating unit represented by formula (4);
a weight of the non-ionic emulsifier is 2-20% of a weight of the polycarbonate diol; the non-ionic emulsifier is a diblock emulsifier and/or a triblock emulsifier; wherein:
the diblock emulsifier includes a segment of a chemical structure represented by formula (5);

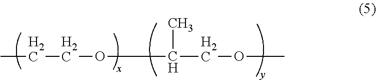

in formula (5), x and y are integers from 1 to 100, and x/(x+y)=35-85%;
the triblock emulsifier includes a segment of a chemical structure represented by formula (6);

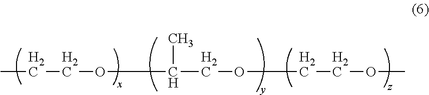

in formula (6), x, y and z are integers from 1 to 100, and (x+z)/(x+y+z)=35-85%.

According to a second aspect of the present application, a preparation method of the aqueous polyol dispersion of the first aspect is disclosed and includes the following steps: mixing the polycarbonate diol and the non-ionic emulsifier and adding the water for emulsification to obtain the aqueous polyol dispersion.

According to a third aspect of the present application, an application of the aqueous polyol dispersion of the first aspect is disclosed and includes: applying the aqueous polyol dispersion in an aqueous two-component soft-feel coating.

### DETAILED DESCRIPTION

The present application is further elaborated below in combination with examples. These examples are used only to illustrate the present application, rather than to limit the scope of the present application. Experimental methods without specific conditions in the following examples are usually used in accordance with conventional conditions in the art or conditions as recommended by manufacturers; and all raw materials and reagents used, unless otherwise specified, are raw materials and reagents that can be obtained from conventional markets and other commercial approaches. Any non-substantial changes and substitutions made by a person skilled in the conventional art on the basis of the present application fall within the scope of protection of the present application.

“Polycarbonate diol” used herein means a polymer or a copolymer including a terminal hydroxyl group and a repeating unit represented by formula (1),

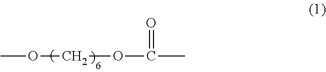

“Polycarbonate diol” may also be a copolymer further including at least one of a repeating unit represented by formula (2), a repeating unit represented by formula (3) and a repeating unit represented by formula (4),

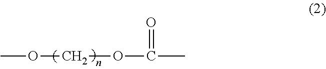

In formula (2), n is either 4 or 5;

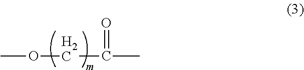

In formula (3), m is either 4 or 5;

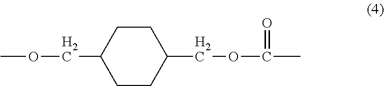

“Diblock emulsifier” as used herein includes a segment represented by formula (5),

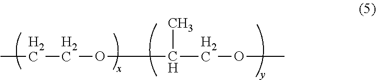

In formula (5), x and y are integers from 1 to 100.

“Triblock emulsifier” as used herein includes a segment represented by formula (6),

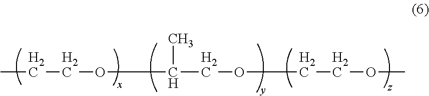

In formula (6), x, y and z are integers from 1 to 100.

In the following examples and comparative examples, experimental methods used are conventional unless otherwise specified; the materials, reagents and the like can be obtained from commercial approaches unless otherwise specified.

### Example 1

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of Pluronic PE 9400 emulsifier (purchased from BASF Corporation, and this non-ionic emulsifier is a triblock copolymer consisting of polyoxyethylene, polyoxypropylene and polyoxyethylene parts) for 1 h at room temperature, and then slowly dripping 50.0 g of deionized water therein under high-speed dispersion for about 2 h to obtain an opalescent aqueous polyol dispersion with a solid content of 50.0 wt %.

### Example 2

The present example provides an aqueous polyol dispersion and a preparation method thereof.

The aqueous polyol dispersion of the present example includes a polycarbonate diol, a non-ionic emulsifier, a co-solvent and water. The polycarbonate diol of the present example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Stirring 46.0 g of polycarbonate diol with a molecular weight of 2000 (UBE ETERNACOLL PH-200, which uses 1,5-pentanediol and 1,6-hexanediol as polymerization monomers, wherein a molar ratio of 1,5-pentanediol to 1,6-hexanediol is about 50:50), 4.0 g of Pluronic PE 9400 emulsifier and 5.0 g of propylene glycol butyl ether for 1 h at room temperature, and then slowly dripping 45.0 g of deionized water therein under high-speed dispersion for about 2 h to obtain an opalescent aqueous polyol dispersion with a solid content of 50.0 wt %.

### Example 3

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Stirring 46.0 g of polycarbonate diol (a polycarbonate diol synthesized using 1,5-pentanediol and 1,6-hexanediol as polymerization monomers, following a method similar to Embodiment 2 of Patent CN102317334A, with only 1,4-butanediol replaced by 1,5-pentanediol, wherein a molar ratio of 1,5-pentanediol to 1,6-hexanediol is about 25:75) and 4.0 g of Pluronic PE 9400 emulsifier for 1 h at room temperature, and then slowly dripping 50.0 g of deionized water therein under high-speed dispersion for about 2 h to obtain an opalescent aqueous polyol dispersion with a solid content of 50.0 wt %.

### Example 4

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Stirring 46.0 g of polycarbonate diol (synthesized following a method of Embodiment 2 of Patent CN102317334A, with a hydroxyl value of 57.3 mg KOH/g, wherein a molar ratio of 1,4-butanediol to 1,6-hexanediol is about 75:25) and 4.0 g of Pluronic PE 9400 emulsifier for 1 h at room temperature, and then slowly dripping 50.0 g of deionized water therein under high-speed dispersion for about 2 h to obtain an opalescent aqueous polyol dispersion with a solid content of 50.0 wt %.

### Example 5

The present example provides an aqueous polyol dispersion and a preparation method thereof.

The aqueous polyol dispersion of the present example includes a polycarbonate diol, a non-ionic emulsifier, a co-solvent and water. The polycarbonate diol of the present example is a polycarbonate diol including a terminal hydroxyl group, a repeating unit represented by formula (1) and a repeating unit represented by formula (4). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Stirring 46.0 g of polycarbonate diol with a molecular weight of 900 (UBE ETERNACOLL UM-90 (⅓), which uses 1,4-cyclohexanedimethanol and 1,6-hexanediol as polymerization monomers, wherein a molar ratio of 1,4-cyclohexanedimethanol to 1,6-hexanediol is about 25:75), 4.0 g of Pluronic PE 9400 emulsifier and 5.0 g of propylene glycol butyl ether for 1 h at room temperature, and then slowly dripping 45.0 g of deionized water therein under high-speed dispersion for about 2 h to obtain an opalescent aqueous polyol dispersion with a solid content of 50.0 wt %.

### Example 6

The present example includes an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (3). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Synthesizing a polycaprolactone-modified polycarbonate diol by the following method: mixing 75.0 g of polycarbonate diol with a molecular weight of 1000 (UBE ETERNACOLL UH-100, which uses 1,6-hexanediol as polymerization monomer), 25.0 g of ¿-caprolactone and 0.05 g of stannous octoate, and heating a resulting mixture to 200° C. for 8 h to obtain a polycaprolactone-modified polycarbonate diol with a molecular weight of 1330, wherein a molar ratio of ε-caprolactone to 1,6-hexanediol is about 30:70.

Stirring 46.0 g of the above synthesized polycaprolactone-modified polycarbonate diol and 4.0 g of Pluronic PE 9400 emulsifier for 1 h at room temperature, and then slowly dripping 50.0 g of deionized water therein in under high-speed dispersion for about 2 h to obtain an opalescent aqueous polyol dispersion with a solid content of 50.0 wt %.

### Example 7

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (3). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Synthesizing a polyvalerolactone-modified polycarbonate diol by the following method: mixing 75.0 g of polycarbonate diol with a molecular weight of 1000 (UBE ETERNACOLL UH-100, which uses 1,6-hexanediol as a polymerization monomer), 25.0 g of δ-valerolactone and 0.05 g of stannous octoate, and heating a resulting mixture to 200° C. for 8 h to obtain a polyvalerolactone-modified polycarbonate diol with a molecular weight of 1330, wherein a molar ratio of δ-valerolactone to 1, 6-hexanediol is about 32:68.

Stirring 46.0 g of the above synthesized polyvalerolactone-modified polycarbonate diol and 4.0 g of Pluronic PE 9400 emulsifier for 1 h at room temperature, and then slowly dripping 50.0 g of deionized water therein under high-speed dispersion for about 2 h to obtain an opalescent aqueous polyol dispersion with a solid content of 50.0 wt %.

### Example 8

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1), a repeating unit represented by formula (2) and a repeating unit represented by formula (3). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Synthesizing a polycaprolactone-modified polycarbonate diol by the following method: mixing 75.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50), 25.0 g of ε-caprolactone and 0.05 g of stannous octoate, and heating a resulting mixture to 200° C. for 8 h to obtain a polycaprolactone-modified polycarbonate diol with a molecular weight of 1330, wherein a molar ratio of ¿-caprolactone to 1,5-pentanediol to 1,6-hexanediol is about 28:36:36.

Stirring 46.0 g of the above synthesized polycaprolactone-modified polycarbonate diol and 4.0 g of Pluronic PE 9400 emulsifier for 1 h at room temperature, and then slowly dripping 50.0 g of deionized water therein under high-speed dispersion for about 2 h to obtain an opalescent aqueous polyol dispersion with a solid content of 50.0 wt %.

### Example 9

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 80%, and a weight of the emulsifier is 8.7% of a weight of the polycarbonate diol. For more details, please refer to the following preparation method and Table 1.

The preparation method of the aqueous polyol dispersion of the present example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of Pluronic PE 6800 emulsifier (purchased from BASF Corporation, and this non-ionic emulsifier is a triblock copolymer consisting of polyoxyethylene, polyoxypropylene and polyoxyethylene parts) for 1 h at room temperature, and then slowly dripping 50.0 g of deionized water therein under high-speed dispersion for about 2 h to obtain an opalescent aqueous polyol dispersion with a solid content of 50.0 wt %.

### Example 10

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (2). The non-ionic emulsifier is a diblock emulsifier, a molar ratio of a polyoxyethylene segment to a sum of the polyoxyethylene segment and a polyoxypropylene segment in the emulsifier is 55%, and a weight of the emulsifier is 8.7% of a weight of the polycarbonate diol. For more details, please refer to the following preparation method and Table 1.

The preparation method of the aqueous polyol dispersion of the present example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of Maxemul 7102 emulsifier (purchased from the company Croda, and this non-ionic emulsifier is a diblock copolymer consisting of polyoxyethylene and polyoxypropylene parts) for 1 h at room temperature, and then slowly dripping 50.0 g of deionized water therein under high-speed dispersion for about 2 h to obtain an opalescent aqueous polyol dispersion with a solid content of 50.0 wt %.

### Example 11

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1), a repeating unit represented by formula (2), a repeating unit represented by formula (3) and a repeating unit represented by formula (4). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present example includes the following steps:

Synthesizing Polycaprolactone-modified polycarbonate diol by the following method: mixing 90.0 g of polycarbonate diol with a molecular weight of 1000 (a polycarbonate diol synthesized using 1,5-pentanediol, 1,4-cyclohexanedimethanol and 1,6-hexanediol as polymerization monomers, following a method similar to Embodiment 2 of Patent CN102317334A, but replacing a molar ratio of 75:25 for 1,5-pentanediol to 1,6-hexanediol witha molar ratio of 25:25:50 for 1,5-pentanediol, 1,4-cyclohexanedimethanol and 1,6-hexanediol), 10.0 g of &-caprolactone and 0.05 g of stannous octoate, and heating a resulting mixture to 200° C. for 8 h to obtain a polycaprolactone-modified polycarbonate diol, wherein a molar ratio of ε-caprolactone to 1,5-pentanediolto 1,4-cyclohexanedimethanol to 1,6-hexanediol is about 11:22:22:45.

Stirring 46.0 g of the above synthesized polycaprolactone-modified polycarbonate diol and 4.0 g of Pluronic PE 9400 emulsifier for 1 h at room temperature, and then slowly dripping 50.0 g of deionized water therein under high-speed dispersion for about 2 h to obtain an opalescent aqueous polyol dispersion with a solid content of 50.0 wt %.

### Example 12

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 2.2% of a weight of the polycarbonate diol. For more details, please refer to the following preparation method and Table 1.

The preparation method of the aqueous polyol dispersion of the present example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 1.0 g of Pluronic PE 9400 emulsifier for 1 h at room temperature, and then slowly dripping 47.0 g of deionized water therein under high-speed dispersion for about 2 h to obtain an opalescent aqueous polyol dispersion with a solid content of 50.0 wt %.

### Example 13

The present example provides an aqueous polyol dispersion and a preparation method thereof.

The aqueous polyol dispersion of the present example includes a polycarbonate diol, a non-ionic emulsifier and water. The polycarbonate diol of the present example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 19.1% of a weight of the polycarbonate diol. For more details, please refer to the following preparation method and Table 1.

The preparation method of the aqueous polyol dispersion of the present example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 8.8 g of Pluronic PE 9400 emulsifier for 1 h at room temperature, and then slowly dripping 54.8 g of deionized water therein under high-speed dispersion for about 2 h to obtain an opalescent aqueous polyol dispersion with a solid content of 50.0 wt %.

### Comparative Example 1

The present comparative example provides an aqueous polyol dispersion and a preparation method thereof.

The aqueous polyol dispersion of the present comparative example includes a polycarbonate diol, a non-ionic emulsifier and water. The polycarbonate diol of the present comparative example is a polycarbonate diol including a terminal hydroxyl group and a repeating unit represented by formula (1). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present comparative example includes the following steps:

Stirring 46.0 g of polycarbonate diol with a molecular weight of 1000 (UBE ETERNACOLL UH-100, which uses 1,6-hexanediol as a polymerization monomer) and 4.0 g of Pluronic PE 9400 emulsifier for 1 h at room temperature, and then slowly dripping 50.0 g of deionized water therein under high-speed dispersion for about 2 h to obtain an opalescent aqueous polyol dispersion with a solid content of 50.0 wt %.

### Comparative Example 2

The present comparative example provides an aqueous polyol dispersion and a preparation method thereof.

The aqueous polyol dispersion of the present comparative example includes a polycarbonate diol, a non-ionic emulsifier, a co-solvent and water. The polycarbonate diol of the present comparative example is a polycarbonate diol including a terminal hydroxyl group, a repeating unit represented by formula (1) and a repeating unit represented by formula (4). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present comparative example includes the following steps:

Stirring 46.0 g of polycarbonate diol with a molecular weight of 900 (UBE ETERNACOLL UM-90 (3/1), which uses 1,4-cyclohexanedimethanol and 1,6-hexanediol as polymerization monomers, wherein a molar ratio of 1,4-cyclohexanedimethanol to 1,6-hexanediol is about 75:25), 4.0 g of Pluronic PE 9400 emulsifier and 5.0 g of propylene glycol butyl ether for 1 h at room temperature, and then slowly dripping 45.0 g of deionized water therein under high-speed dispersion for about 2 h to obtain an opalescent aqueous polyol dispersion with a solid content of 50.0 wt %.

### Comparative Example 3

The present comparative example provides an aqueous polyol dispersion and a preparation method thereof.

The aqueous polyol dispersion of the present comparative example includes a polycarbonate diol, a non-ionic emulsifier, a co-solvent and water. The polycarbonate diol of the present comparative example is a polycarbonate diol including a terminal hydroxyl group, a repeating unit represented by formula (1) and a repeating unit represented by formula (4). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present comparative example includes the following steps:

Stirring 46.0 g of polycarbonate diol with a molecular weight of 900 (UBE ETERNACOLL UM-90 (1/1), which uses 1,4-cyclohexanedimethanol and 1,6-hexanediol as polymerization monomers, wherein a molar ratio of 1,4-cyclohexanedimethanol to 1,6-hexanediol is about 50:50), 4.0 g of Pluronic PE 9400 emulsifier and 5.0 g of propylene glycol butyl ether for 1 h at room temperature, and then slowly dripping 45.0 g of deionized water therein under high-speed dispersion for about 2 h to obtain an opalescent aqueous polyol dispersion with a solid content of 50.0 wt %.

### Comparative Example 4

The present comparative example provides an aqueous polyol dispersion and a preparation method thereof.

The aqueous polyol dispersion of the present comparative example includes a polycarbonate diol, a non-ionic emulsifier and water. The polycarbonate diol of the present comparative example is a polycarbonate diol including a terminal hydroxyl group, a repeating unit represented by formula (1) and a repeating unit represented by formula (3). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 8.7% of a weight of the polycarbonate diol. For more details, please refer to the following preparation method and Table 1.

The preparation method of the aqueous polyol dispersion of the present comparative example includes the following steps:

Synthesizing a polycaprolactone-modified polycarbonate diol by the following method: mixing 60.0 g of polycarbonate diol with a molecular weight of 1000 (UBE ETERNACOLL UH-100, which uses 1,6-hexanediol as polymerization monomer), 40.0 g of ε-caprolactone and 0.05 g of stannous octoate, and heating a resulting mixture to 200° C. for 8 h to obtain the polycaprolactone-modified polycarbonate diol, wherein a molar ratio of ε-caprolactone to 1,6-hexanediol is about 46:54.

Stirring 46.0 g of the above synthesized polycaprolactone-modified polycarbonate diol and 4.0 g of Pluronic PE 9400 emulsifier for 1 h at room temperature, and then slowly dripping 50.0 g of deionized water therein under high-speed dispersion for about 2 h to obtain an opalescent aqueous polyol dispersion with a solid content of 50.0 wt %.

### Comparative Example 5

The present comparative example provides an aqueous polyol dispersion and a preparation method thereof.

The aqueous polyol dispersion of the present comparative example includes a polycarbonate diol, a non-ionic emulsifier and water. The polycarbonate diol of the present comparative example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 40%, and a weight of the emulsifier is 0.9% of a weight of the polycarbonate diol. For more details, please refer to the following preparation method and Table 1.

A preparation method of the aqueous polyol dispersion of the present comparative example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 0.4 g of Pluronic PE 9400 emulsifier for 1 h at room temperature, and then slowly dripping 46.4 g of deionized water therein under high-speed dispersion for about 2 h. A stable emulsion cannot be obtained, and stratification occurs after standing overnight.

### Comparative Example 6

The present comparative example provides an aqueous polyol dispersion and a preparation method thereof.

The aqueous polyol dispersion of the present comparative example includes a polycarbonate diol, a non-ionic emulsifier and water. The polycarbonate diol of the present comparative example is a polycarbonate diol including a terminal hydroxyl group, a repeating unit represented by formula (1) and a repeating unit represented by formula (2). The non-ionic emulsifier is a triblock emulsifier, a molar ratio of the polyoxyethylene segment to a sum of the polyoxyethylene segment and a polyoxypropylene segment in the emulsifier is 20%, and a weight of the emulsifier is 8.7% of a weight of the polycarbonate diol. For more details, please refer to the following preparation method and Table 1.

The preparation method of the aqueous polyol dispersion of the present comparative example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of Pluronic PE 9200 emulsifier (purchased from BASF Corporation, and this non-ionic emulsifier is a triblock copolymer consisting of polyoxyethylene, polyoxypropylene and polyoxyethylene parts) for 1 h at room temperature, and then slowly dripping 50.0 g of deionized water therein under high-speed dispersion for about 2 h. A stable emulsion cannot be obtained, and stratification occurs after standing overnight.

### Comparative Example 7

The present comparative example provides an aqueous polyol dispersion and a preparation method thereof.

The aqueous polyol dispersion of the present comparative example includes a polycarbonate diol, a non-ionic emulsifier and water. The polycarbonate diol of the present comparative example is a polycarbonate diol including a terminal hydroxyl group, a repeating unit represented by formula (1) and a repeating unit represented by formula (2). The non-ionic emulsifier is a triblock emulsifier, a molar ratio of a polyoxyethylene segment to a sum of the polyoxyethylene segment and a polyoxypropylene segment in the emulsifier is 90%, and a weight of the emulsifier is 8.7% of a weight of the polycarbonate diol. For more details, please refer to the following preparation method and Table 1.

The preparation method of the aqueous polyol dispersion of the present comparative example includes the following steps:

Synthesizing a triblock copolymer consisting of polyoxyethylene, polyoxypropylene, and polyoxyethylene parts by the following method, wherein a molar ratio of a polyoxyethylene segment to a sum of the polyoxyethylene segment and a polyoxypropylene segment in the emulsifier is 90%: Introducing 20.0 g of polypropylene glycol with a molecular weight of 2000 and 0.63 g of sodium methoxide into a pressure reactor, charging the pressure reactor with nitrogen at room temperature, and then evacuating the pressure reactor. Subsequently, heating a resulting mixture to 115° C., maintaining a reaction at 115° C. for about 4 h, and then adding 180.0 g of ethylene oxide thereto to continue the reaction for 2 h. Finally, cooling a resulting product to below 90° C. to obtain a triblock copolymer with an hydroxyl value of 56 mgKOH/g.

Stirring 46.0 g of polycarbonate diol with a molecular weight of 1000 (UBE ETERNACOLL PH-100, which uses 1,5-pentanediol and 1,6-hexanediol as polymerization monomers, wherein the molar ratio of 1,5-pentanediol to 1,6-hexanediol is about 50:50) and 4.0 g of the above synthesized triblock emulsifier for 1 h at room temperature, and then slowly dripping 50.0 g of deionized water therein under high-speed dispersion for about 2 h. A stable emulsion cannot be obtained, and stratification occurs after standing overnight.

### Comparative Example 8

The present comparative example provides an aqueous polyol dispersion and a preparation method thereof.

The aqueous polyol dispersion of the present comparative example includes a polycarbonate diol, a emulsifier and water. The polycarbonate diol of the present comparative example is a polycarbonate diol including a terminal hydroxyl group, a repeating unit represented by formula (1) and a repeating unit represented by formula (2). The emulsifier is a non-block emulsifier. For more details, please refer to the following preparation method.

The preparation method of the aqueous polyol dispersion of the present comparative example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of mixed polyethers (containing 40 wt % polyethylene glycol 4000 and 60 wt % polypropylene glycol 4000, non-blocked and merely physically blended) for 1 h at room temperature, then slowly dripping 50.0 g of deionized water therein under high-speed dispersion for about 2 h. A stable emulsion cannot be obtained, and stratification occurs after standing overnight.

### Comparative Example 9

The present comparative example provides an aqueous polyol dispersion and a preparation method thereof.

The aqueous polyol dispersion of the present comparative example includes a polycarbonate diol, a emulsifier and water. The polycarbonate diol of the present comparative example is a polycarbonate diol including a terminal hydroxyl group, a repeating unit represented by formula (1) and a repeating unit represented by formula (2). The emulsifier is an emulsifier containing only polyoxyethylene. For more details, please refer to the following preparation method.

The preparation method of the aqueous polyol dispersion of the present comparative example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of polyethylene glycol 4000 1 h at room temperature, and then slowly dripping 50.0 g of deionized water therein under high-speed dispersion for about 2 h. A stable emulsion cannot be obtained, and stratification occurs after standing overnight.

### Comparative Example 10

The present comparative example provides an aqueous polyol dispersion and a preparation method thereof.

The aqueous polyol dispersion of the present comparative example includes a polycarbonate diol, a emulsifier and water. The polycarbonate diol of the present comparative example is a polycarbonate diol including a terminal hydroxyl group, a repeating unit represented by formula (1) and a repeating unit represented by formula (2). The emulsifier is a fatty alcohol polyoxyethylene ether emulsifier containing only polyoxyethylene. For more details, please refer to the following preparation method.

The preparation method of the aqueous polyol dispersion of the present comparative example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of fatty alcohol polyoxyethylene etherAEO-9 (without a polyoxypropylene segment) for 1 h at room temperature, and then slowly stirring 50.0 g of deionized water therein under high-speed dispersion for about 2 h. A stable emulsion cannot be obtained, and stratification occurs after standing overnight.

### Comparative Example 11

The present comparative example provides an aqueous polyol dispersion and a preparation method thereof.

The aqueous polyol dispersion of the present comparative example includes a polycarbonate diol, a emulsifier and water. The polycarbonate diol of the present comparative example is a polycarbonate diol including a terminal hydroxyl group, a repeating unit represented by formula (1) and a repeating unit represented by formula (2). The emulsifier is an anionic emulsifier. For more details, please refer to the following preparation method.

The preparation method of the aqueous polyol dispersion of the present comparative example includes the following steps:

Stirring 46.0 g of polycarbonate diol with a molecular weight of 1000 (UBE ETERNACOLL PH-100, which uses 1,5-pentanediol and 1,6-hexanediol as polymerization monomers, wherein a molar ratio of 1,5-pentanediol to 1,6-hexanediol is about 50:50) and 4.0 g of sodium dodecylbenzene sulfonate emulsifier for 1 h at room temperature, and then slowly dripping 50.0 g of deionized water therein under high-speed dispersion for about 2 h. A stable aqueous dispersion cannot be obtained, and stratification occurs obviously.

### Example 14

The present example provides an application of an aqueous polyol dispersion in an aqueous two-component soft-feel coating.

The aqueous two-component soft-feel coating of the present example is an aqueous two-component matte soft-feel coating, including a component A and a component B, wherein:

The component A includes the following components calculated according to parts by weight: 64 parts of the aqueous polyol dispersion of any one of Examples 1-13, 21 parts of water, 0.7 parts of a defoaming agent, 0.5 parts of a dispersant, 6.5 parts of matting powder, 0.5 parts of a wetting agent, 5.4 parts of a film-forming auxiliary, 1 part of an aqueous organotin catalyst, 0.4 parts of a thickening agent.

The component B is an aqueous isocyanate curing agent.

A ratio of a molar amount of-OH (hydroxyl group) in the aqueous polyol dispersion in the component A to a molar amount of-NCO (isocyanate group) in the aqueous isocyanate curing agent is 1.5.

TABLE 1
Parameters Related to Polycarbonate Diols and Nonionic Emulsifiers of
Examples 1-13 and Comparative Examples 1-7

| | $\frac{{n}_{1}}{{n}_{1} + {n}_{2} + {n}_{3} + {n}_{4}}$ | $\frac{{n}_{2}}{{n}_{1} + {n}_{2} + {n}_{3} + {n}_{4}}$ | $\frac{{n}_{3}}{{n}_{1} + {n}_{2} + {n}_{3} + n}$ | $\frac{{n}_{4}}{{n}_{1} + {n}_{2} + {n}_{3} + n}$ | Emulsifier structure | $\frac{{n}_{5}}{{n}_{5} + {n}_{6}}$ | $\frac{{m}_{2}}{{m}_{1}}$ |
|---|---|---|---|---|---|---|---|
| Example 1 | 50% | 50% | 0% | 0% | triblock | 40% | 8.7% |
| Example 2 | 50% | 50% | 0% | 0% | triblock | 40% | 8.7% |
| Example 3 | 75% | 25% | 0% | 0% | triblock | 40% | 8.7% |
| Example 4 | 25% | 75% | 0% | 0% | triblock | 40% | 8.7% |
| Example 5 | 75% | 0% | 0% | 25% | triblock | 40% | 8.7% |
| Example 6 | 70% | 0% | 30% | 0% | triblock | 40% | 8.7% |
| Example 7 | 68% | 0% | 32% | 0% | triblock | 40% | 8.7% |
| Example 8 | 36% | 36% | 28% | 0% | triblock | 40% | 8.7% |
| Example 9 | 50% | 50% | 0% | 0% | triblock | 80% | 8.7% |
| Example 10 | 50% | 50% | 0% | 0% | diblock | 55% | 8.7% |
| Example 11 | 45% | 22% | 11% | 22% | triblock | 40% | 8.7% |
| Example 12 | 50% | 50% | 0% | 0% | triblock | 40% | 2.2% |
| Example 13 | 50% | 50% | 0% | 0% | triblock | 40% | 19.1% |
| Comparative | 100% | 0% | 0% | 0% | triblock | 40% | 8.7% |
| Example 1 | | | | | | | |
| Comparative | 25% | 0% | 0% | 75% | triblock | 40% | 8.7% |
| Example 2 | | | | | | | |
| Comparative | 50% | 0% | 0% | 50% | triblock | 40% | 8.7% |
| Example 3 | | | | | | | |
| Comparative | 54% | 0% | 46% | 0% | triblock | 40% | 8.7% |
| Example 4 | | | | | | | |
| Comparative | 50% | 50% | 0% | 0% | triblock | 40% | 0.9% |
| example 5 | | | | | | | |
| Comparative | 50% | 50% | 0% | 0% | triblock | 20% | 8.7% |
| Example 6 | | | | | | | |
| Comparative | 50% | 50% | 0% | 0% | triblock | 90% | 8.7% |
| Example 7 | | | | | | | |

In Table 1, n₁, n₂, n₃ and n₄ respectively represent a molar amount of the repeating unit represented by formula (1), a molar amount of the repeating unit represented by formula (2), a molar amount of the repeating unit represented by formula (3) and a molar amount of the repeating unit represented by formula (4); n₅ and n₆ respectively represent a molar amount of the polyoxyethylene segment and a molar amount of the polyoxypropylene segment; m₂/m₁ is a ratio of a weight of the non-ionic emulsifier to the weight of the polycarbonate diol in the aqueous polyol dispersion (m₂ is the weight of the non-ionic emulsifier, m₁ is the weight of the polycarbonate diol).

### Performance Test

Since stable aqueous polyol dispersions cannot be formed in Comparative Examples 5-11, this specification only tested performances of aqueous polyol dispersions provided by Examples 1-13 and Comparative Examples 1-4. A process is as follows.

The aqueous polyol dispersions provided by Examples 1-13 and Comparative Examples 1-4 were formulated with aqueous isocyanate curing agents to form AB two-component aqueous two-component matte soft-feel coatings 1-13 (corresponding to Examples 1-13) and aqueous two-component matte soft-feel coatings 14-17 (corresponding to Comparative Examples 1-4), respectively. And related properties of the coatings 1-17 were tested. A formulation of a component A in each coating is shown in Table 2, and a component B is a commercialized aqueous anionic isocyanate curing agent: OS-9016 (Guanzhi New Material, with an NCO content of 16.3 wt % and a solid content of 80 wt %). A molar ratio of the aqueous polyol dispersion and a aqueous isocyanate curing agent component was calculated according to NCO/OH=1.5 to obtain a dosage of each component.

TABLE 2
Formulations of Component A in Coatings 1-17 (parts)

| | | Coatings | | | | | | | | | | | | | | | | |
|---|---|---|---|---|---|---|---|---|---|---|---|---|---|---|---|---|---|---|
| Component | Specific types | 1 | 2 | 3 | 4 | 5 | 6 | 7 | 8 | 9 | 10 | 11 | 12 | 13 | 14 | 15 | 16 | 17 |
| Aqueous | Example 1 | 64 | / | / | / | / | / | / | / | / | / | / | / | / | / | / | / | / |
| polyol | Example 2 | / | 64 | / | / | / | / | / | / | / | / | / | / | / | / | / | / | / |
| dispersion | Example 3 | / | / | 64 | / | / | / | / | / | / | / | / | / | / | / | / | / | / |
| | Example 4 | / | / | / | 64 | / | / | / | / | / | / | / | / | / | / | / | / | / |
| | Example 5 | / | / | / | / | 64 | / | / | / | / | / | / | / | / | / | / | / | / |
| | Example 6 | / | / | / | / | / | 64 | / | / | / | / | / | / | / | / | / | / | / |
| | Example 7 | / | / | / | / | / | / | 64 | / | / | / | / | / | / | / | / | / | / |
| | Example 8 | / | / | / | / | / | / | / | 64 | / | / | / | / | / | / | / | / | / |
| | Example 9 | / | / | / | / | / | / | / | / | 64 | / | / | / | / | / | / | / | / |
| | Example 10 | / | / | / | / | / | / | / | / | / | 64 | / | / | / | / | / | / | / |
| | Example 11 | / | / | / | / | / | / | / | / | / | / | 64 | / | / | / | / | / | / |
| | Example 12 | / | / | / | / | / | / | / | / | / | / | / | 64 | / | / | / | / | / |
| | Example 13 | / | / | / | / | / | / | / | / | / | / | / | / | 64 | / | / | / | / |
| | Comparative | / | / | / | / | / | / | / | / | / | / | / | / | / | 64 | / | / | / |
| | Example 1 | | | | | | | | | | | | | | | | | |
| | Comparative | / | / | / | / | / | / | / | / | / | / | / | / | / | / | 64 | / | / |
| | Example 2 | | | | | | | | | | | | | | | | | |
| | Comparative | / | / | / | / | / | / | / | / | / | / | / | / | / | / | / | 64 | / |
| | Example 3 | | | | | | | | | | | | | | | | | |
| | Comparative | / | / | / | / | / | / | / | / | / | / | / | / | / | / | / | / | 64 |
| | Example 4 | | | | | | | | | | | | | | | | | |

| | | |
|---|---|---|
| Water | Purified water | 21 |
| Defoaming | Tego902W | 0.2 |
| agent | (Evonik) | |
| | Surfynol104E | 0.5 |
| | (Evonik) | |
| Dispersant | TEGO | 0.5 |
| | Dispers 755W | |
| | (Evonik) | |
| Matting | E1011 | 6.5 |
| powder | (Tosoh) | |
| Wetting | TEGO | 0.5 |
| agent | Twin4100 | |
| | (Evonik) | |
| Film | DPnB | 3 |
| forming | (Dow) | |
| auxiliary | DPM | 2.4 |
| | (Dow) | |
| Aqueous | BorchersLH10 | 1 |
| organotin | (Borchers) | |
| catalyst | | |
| Thickening | OS-2020 | 0.4 |
| agent | (Guanzhi) | |

The component A and the component B of each coating of the coatings 1-17 were mixed, respectively. Then, water was added in each resulting mixture to adjust to an appropriate viscosity (Tu-4 Cup Viscosity is 20-30 seconds) for spray construction to form a coating film, respectively. A construction substrate was a black PC substrate plastic board, a dry film thickness was 20±3 μm, and a drying condition was 70° C. for 4 h followed by an overnight placement at room temperature. The following performance tests were then carried out on the coating film:
Gloss test: Test according to GB 1743-1979 (1989) and record a 60° gloss.
Matte powder arrangement effect test: Observe a surface of the coating film for any floating uneven state.
Soft-feel test: Rate the soft-feel of the coating film on a scale of 1-10 with 10 being the best and 1 being the worst.
RCA abrasion resistance test: Test according to ASTM F2357-04 standard with a load of 175 g.

Test results are shown in Table 3:

TABLE 3
Performance Test Results of Coatings 1-17

| | Coatings | | | | | | | | |
|---|---|---|---|---|---|---|---|---|---|
| Item | 1 | 2 | 3 | 4 | 5 | 6 | 7 | 8 | 9 |
| 60° gloss | 7.5 | 8.2 | 7.8 | 7.1 | 8.2 | 8.9 | 8.2 | 7.5 | 9.1 |
| Matte powder | excellent | excellent | excellent | excellent | excellent | excellent | excellent | excellent | excellent |
| arrangement | | | | | | | | | |
| Softfeel rating | 9 | 10 | 8 | 9 | 8 | 8 | 9 | 9 | 9 |
| RCA abrasion | 102 | 66 | 104 | 109 | 88 | 68 | 75 | 62 | 99 |
| resistance | | | | | | | | | |

| | Coatings | | | | | | | | |
|---|---|---|---|---|---|---|---|---|---|
| Item | 10 | 11 | 12 | 13 | 14 | 15 | 16 | 17 | / |
| 60° gloss | 8.6 | 8.3 | 7.9 | 8.2 | 7.6 | 7.7 | 8.5 | 8.0 | / |
| Matte powder | excellent | excellent | excellent | excellent | excellent | excellent | excellent | excellent | / |
| arrangement | | | | | | | | | |
| Softfeel rating | 9 | 9 | 9 | 9 | 5 | 3 | 5 | 8 | / |
| RCA abrasion | 105 | 71 | 108 | 86 | 112 | 48 | 66 | 25 | / |
| resistance | | | | | | | | | |

It can be seen from the above results that coating films formed by aqueous two-component soft-feel coatings 1-13, which are prepared from the aqueous polyol dispersions of Examples 1-13 of the present application, exhibit good matte powder arrangement effect, outstanding soft-feel and excellent RCA abrasion resistance. However, the coating 14 utilizes the aqueous polyol dispersion of Comparative Example 1, wherein the polycarbonate diol contains only a terminal hydroxyl group and a repeating unit represented by formula (1) i.e., a content of 1,6-hexanediol units is excessively high. This leads to an overly regular structure of the polycarbonate diol with high crystallinity, increasing cohesion force and reducing the soft-feel of the coating film formed by an aqueous two-component soft-feel coating 14 prepared from the aqueous polyol dispersion of Comparative Example 1. The coating 15 utilizes the aqueous polyol dispersion of Comparative Example 2, and the coating 16 utilizes the aqueous polyol dispersion of Comparative Example 3. However, both aqueous polyol dispersions in Comparative Example 2 and Comparative Example 3 suffer from an excessive content of a repeating unit represented by formula (4) in the polycarbonate diol, i.e., an excess of 1,4-cyclohexanedimethanol, which deteriorates the soft-feel of coating films prepared therefrom. The coating 17 utilizes the aqueous polyol dispersion of Comparative Example 4, which has an excessive content of a repeating unit represented by formula (3) in the polycarbonate diol, i.e., an overabundance of the polycaprolactone segment, resulting in a decrease in RCA abrasion resistance of the coating film formed by an aqueous two-component soft-feel coating 17 prepared from the aqueous polyol dispersion of Comparative Example 4.

In each example of Examples 1-13 of the present application, a non-ionic emulsifier with a specific structure and a specific molar ratio of a polyoxyethylene segment to a sum of the polyoxyethylene segment and apolyoxypropylene segment is utilized. The non-ionic emulsifier also has a specific weight ratio with respect to the polycarbonate diol, resulting in good stability of the aqueous polyol dispersion in each example of Examples 1-13. However, an aqueous polyol dispersion that does not utilize the non-ionic emulsifier with the specific structure and the specific molar ratio of the polyoxyethylene segment to the sum of the polyoxyethylene segment and the polyoxypropylene segment, nor the specific weight ratio of the non-ionic emulsifier with respect to the polycarbonate diol, are prone to stratification. For example, although the aqueous polyol dispersion of Comparative Example 5 utilizes a non-ionic emulsifier, a weight ratio of the emulsifier to the polycarbonate diol is 0.9%, which is below a defined range of the present application, leading to instability of the aqueous polyol dispersion and a tendency to stratify after standing. Similarly, although the aqueous polyol dispersion of Comparative Example 6 utilizes a non-ionic emulsifier, the molar ratio of the polyoxyethylene segment to the sum of the polyoxyethylene segment and the polyoxypropylene segment in the non-ionic emulsifier is 20%, which is below a defined range of the present application, leading to instability of the aqueous polyol dispersion and a tendency to stratify after standing. In the case of the aqueous polyol dispersion of Comparative Example 7, a molar ratio of a polyoxyethylene segment to a sum of the polyoxyethylene segment and a polyoxypropylene segment in the non-ionic emulsifier is 90%, which is larger than the defined range of the present application, leading to instability of the aqueous polyol dispersion and a tendency to stratify after standing. The aqueous polyol dispersion of Comparative Example 8 utilizes physical blended polyethylene glycol and polypropylene glycol as the emulsifier instead of a block emulsifier, which also fails to obtain a stable aqueous polyol dispersion and stratification is likely to occur after standing. The aqueous polyol dispersion of Comparative Example 9 uses polyethylene glycol 4000 containing only the polyoxyethylene as the emulsifier, the aqueous polyol dispersion of Comparative Example 10 uses fatty alcohol polyoxyethylene etherAEO-9 containing only polyoxyethylene as the emulsifier. Both emulsifiers are not a diblock emulsifier or a triblock emulsifier of the present application, and both Comparative Example 9 and Comparative Example 10 fail to obtain stable aqueous polyol dispersions and stratifications are likely to occur after standing. The aqueous polyol dispersion of Comparative Example 11 utilizes an anionic emulsifier, sodium dodecylbenzene sulfonate, which also fails to obtain a stable aqueous dispersion.

Compared with the conventional art, the present application can obtain aqueous soft-feel polyol by selecting and using the polycarbonate diol, the non-ionic emulsifier, the co-solvent and the water. Specifically, the present application limits groups in the polycarbonate diol and a ratio of their amounts of substance, as well as limits a structure of the non-ionic emulsifier and the molar ratio of the polyoxyethylene segment in the non-ionic emulsifier to the sum of the polyoxyethylene segment and polyoxypropylene segment. This enables the aqueous soft-feel polyol to exhibit excellent abrasion resistance, soft-feel, and outstanding stability. The coating film formed by using the aqueous soft-feel polyol dispersion of the present application, when applied to the aqueous two-component soft-feel coating, demonstrates excellent abrasion resistance and soft-feel.

Although the present invention has been disclosed in the form of embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality.

1. An aqueous polyol dispersion, comprising: a polycarbonate diol, a non-ionic emulsifier and water;
wherein, the polycarbonate diol is at least one type of a polycarbonate diol comprising (a), (b), and (c), wherein:
(a) is a terminal hydroxyl group;
(b) is a repeating unit represented by formula (1); 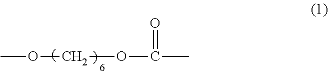
(c) is at least one of a repeating unit represented by formula (2), a repeating unit represented by formula (3) and a repeating unit represented by formula (4); 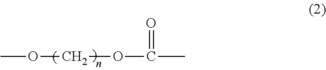
in formula (2), n is either 4 or 5; 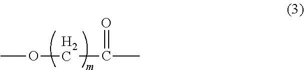
in formula (3), m is either 4 or 5; 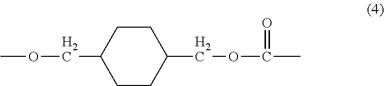
in the polycarbonate diol,
$$\frac{{n}_{l}}{{n}_{1} + {n}_{2} + {n}_{3} + {n}_{4}} = 25 - 75 \% ; \frac{{n}_{2}}{{n}_{1} + {n}_{2} + {n}_{3} + {n}_{4}} = 0 - 75 \% ; \frac{{n}_{3}}{{n}_{1} + {n}_{2} + {n}_{3} + {n}_{4}} = 0 - 30 \% ; \\ \frac{{n}_{4}}{{n}_{1} + {n}_{2} + {n}_{3} + {n}_{4}} = 0 - 30 \% ;$$
n₁ represents a molar amount of the repeating unit represented by formula (1); n₂ represents a molar amount of the repeating unit represented by formula (2); n₃ represents a molar amount of the repeating unit represented by formula (3); n₄ represents a molar amount of the repeating unit represented by formula (4);
a weight of the non-ionic emulsifier is 2-20% of a weight of the polycarbonate diol; the non-ionic emulsifier is a diblock emulsifier and/or a triblock emulsifier; wherein:
the diblock emulsifier comprises a segment represented by formula (5); 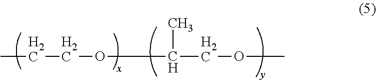
in formula (5), x and y are integers from 1 to 100, and x/(x+y)=35-85%;
the triblock emulsifier comprises a segment represented by formula (6); 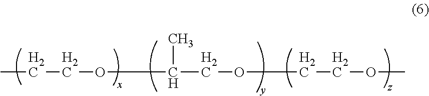
in formula (6), x, y and z are integers from 1 to 100, and (x+z)/(x+y+z)=35-85%.

2. The aqueous polyol dispersion of claim 1, wherein a number average molecular weight of the polycarbonate diol is from 300 to 10000.

3. The aqueous polyol dispersion of claim 1, wherein a solid content of the aqueous polyol dispersion is 40-70 wt %.

4. The aqueous polyol dispersion of claim 1, wherein a weight of the water is 40-400% of a weight of the polycarbonate diol.

5. The aqueous polyol dispersion of claim 1, further comprising a co-solvent.

6. The aqueous polyol dispersion of claim 5, wherein a weight of the co-solvent is 0-10% of the weight of the polycarbonate diol.

7. The aqueous polyol dispersion of claim 5, wherein the co-solvent is at least one of a alcohol ether co-solvent, a alcohol co-solvent, a ether co-solvent, a ester co-solvent and a ketone co-solvent.

8. A preparation method of the aqueous polyol dispersion of claim 1, comprising the following steps:
mixing the polycarbonate diol and the non-ionic emulsifier and adding the water to a resulting mixture for emulsification to obtain the aqueous polyol dispersion.

9. An application of the aqueous polyol dispersion of claim 1, comprising: applying the aqueous polyol dispersion in an aqueous two-component soft-feel coating.
